(19) United States
(12) Patent Application Publication
(10) Pub. No.: US 2018/0213817 A1
(43) Pub. Date: Aug. 2, 2018

(54) CONFECTIONARY PRODUCT

(71) Applicant: Olena Mykolaiivna BOLSHAKOVA, Kyiv (UA)

(72) Inventor: Olena Mykolaiivna BOLSHAKOVA, Kyiv (UA)

(21) Appl. No.: 15/746,832

(22) PCT Filed: Jul. 27, 2016
(86) PCT No.: PCT/UA2016/000094

§ 371 Date: Jan. 23, 2018

(30) Foreign Application Priority Data
Jul. 29, 2015 (UA) U 2015 07565

(51) Int. Cl. A23G 3/48; A23G 3/54; A23G 3/42

(52) U.S. Cl. CPC A23G 3/48; A23V 2002/00; A23G 3/42; A23G 3/54

(57) ABSTRACT

A confectionary product including a body comprised of at least one shape-giving layer, which is made from a pre-prepared berry and/or fruit and/or vegetable mixture with added natural fructose (if necessary) and/or a sugar-containing product (if necessary). The thickness of the shape-giving layer is from 1 to 6 mm.

### CROSS REFERENCE TO RELATED APPLICATION

This application is a national stage entry of PCT/UA2016/000094 filed Jul. 27, 2016, under the International Convention claiming priority over UA Patent Application No. u 2015 07565 filed Jul. 29, 2015.

### TECHNICAL FIELD

The utility model relates to the confectionary industry, particularly to confectionary field thereof and relates to production of sweets based on natural berry and/or fruit, and/or vegetable feedstock of various forms and various colors and tastes.

### BACKGROUND OF THE INVENTION

UA 59325 (IPC A23G 3/00, published on May 10, 2011, Bulletin No. 9/2011) disclosed a cream-paste candy with combined center which contains sugar powder, vegetable fat, pectin, milk products, citric acid, essences, and water, said candy being characterized in containing, as main structure formers of the cream-paste mass, a carrot paste and vegetable-fruit-berry pectin-containing pastes in the following ratio of the crude ingredients, %: powdered sugar: 15-25; vegetable fat: 10-20; pectins: 0.5-4.5; milk products: 25-34; citric acid: 0.08-0.1; essences: 0.06; carrot paste: 5-15; vegetable-fruit-berry pectin-containing pastes: 10-20; water: the rest. The disclosed candy composition has a disadvantage of containing vegetable fats and milk products, thus, the sweets caloric content being increased. Furthermore, the vegetable-fruit-berry pectin-containing paste fails to contain the amount of useful components (vitamins, microelements etc.) which does exist in natural vegetables, fruits and berries.

UA 91082 (IPC A23L 1/06, published on Jun. 25, 2010, Bulletin No 12/2010) disclosed a marmalade containing sand sugar and puree of japonica quince at the following ratio, kg per 100 kg of prepared product: puree of japonica quince: 81; sand sugar: 62. The prepared sweets do always have the three-dimensional body, apple-lemon odor, gelatinous consistence and yellow color. I.e., this disclosed receipt is only used for preparation of a solely one kind of sweets.

RU 2222203 (IPC A23L1/06, A23G3/34, published 27 Jan. 2004) disclosed a method for producing of fruit pastille in the form of cake or roll, said process providing for sorting and gauging fruits, preferably apples, removing pits and stems, baking fruits in pans at the temperature of 80-100° C. in baking chamber, rubbing baked fruits for preparing of pulp, whipping fruit pulp with sugar and egg white, drying pastille mass in sheets at temperature of from 50° C. to 75° C. until crust is formed on pastille mass surface, with drying procedure being initiated at temperature of about higher value of indicated temperature range and finished at about lower temperature range of indicated temperature range; cooling resultant sheets and oiling with pastille mass; forming into cakes or rolls; slightly drying; cooling; dusting with sugar powder and packing for further realization or storage. For producing the pastille cakes, while calculated per one tone of prepared product, used are: 680 kg of sand sugar of standard humidity, 1000 kg of fruit pulp, and 16.9 kg of egg white (approximately from 700 chicken eggs). The disclosed fruit pastille composition has the disadvantage of using preferably apple pulp, and only in some cases 20-25% of apple pulp is substituted with other backed fruits selected from the group consisting of stone fruits such as cherry, and berries such as ashberry, blackcurrant, and cranberry. The resulting products have a slight pink color. A further disadvantage of the known product is that the pastille mass sheets are dried at the temperature of 50-75° C. until crust is formed on pastille mass surface, thus causing both loss of vitamins and other natural useful substances originally contained in pectin and apple pulp, and affecting the sheets flexibility. Moreover, the egg white usage in the composition disables producing thin but elastic sheets, as well as excludes a possibility of such pastille consumption by people allergic to eggs and those avoiding products of animal origin.

RU2490923 (IPC A23G3/00 published on Aug. 27, 2013) disclosed a pastille product manufacture method, said method envisaging preparation of a complex of a mixture of a calcium-containing additive, fruit and/or vegetable powders, citric acid and dry egg protein with subsequent mixing of components till homogeneity. The apple-and-sugar mixture preparation by way of mixing apple puree with sugar sand, homogeneous mixing of the produced complex with a mixture of the apple-sugar mixture, taken at a ratio providing for pH of the produced mass equal to 3.8-5.2, the mass swelling during 20-40 minutes at a temperature of 40-50° C., beating up till the mass volume increases 2-4 times. Introduction of the sugar-molasses syrup with a gelatinising agent into the beaten mass, continuation of beating till production of a stable mass with density equal to 400-900 kg/m³, moulding, structurisation and finishing of the pieces. According to the disclosed process, the components are being used in the following ratio (weight parts): calcium-containing additive: 0.02-0.05, fruit and/or vegetable powders: 4-10, citric acid: 0.2-1.3, dry egg white: 0.8-1.0, apple puree: 30-39, sugar sand for preparing an apple-sugar mixture: 28-39, sugar sand for preparing a sugar-molasses syrup: 20-30, molasses: 10-13, gelatinising agent: 8-13. Apple or blueberry or cranberry powders are used as fruit powders, pumpkin or carrot powders are used as vegetable powders. Calcium lactate or calcium caseinate is used as a calcium-containing additive. As a gelatinising agent, used is agar-agar or carrageenan, or furcellaran, or agaroid, or pectin. As molasses, used is the molasses containing not less than 36% of reducing agents. The disadvantages of the disclosed composition for preparing pastille-like products are as follows: usage of the egg white and gelatinising agents in the composition, said usage worsening organoleptic and structure-mechanical properties of the prepared products; insufficient flexibility and elasticity of the pieces structure, as well as a limited scope of products range as regards the taste and flavor characteristics. Furthermore, usage of said fruit and/or vegetable powders disables preparation of the ready-made products with high contents of natural feedstock components (organic acids, ascorbic acid, pectin, minerals, fibers, vitamins etc.).

This latter solution has been selected as the closest prior art (prototype).

### SUMMARY OF THE INVENTION

The object of the present utility model is to provide a formulation (receipt) of the confectionary product having a high biological value and novel organoleptic properties, while using natural berries, fruits and vegetables only, and while avoiding adding gelatinising agents and egg whites, the suggested product having improved structural-mechanical properties, namely: high elasticity, flexibility and thinness of layers, owing to which factors the product does not change its form under a mechanical effect (cutting), while increasing the consumer properties.

In order to realize the abovementioned object, suggested is a confectionary product including a body comprised of at least one shape-giving layer, which is made of a pre-prepared berry and/or fruit and/or vegetable mixture with added natural fructose (optionally) and/or sugar-containing product (optionally), wherein, according to this utility model, the shape-giving layer is from 1 to 6 mm thin, and the shape-giving layer formulation being selected according to the following components ratio, weight %:

| | |
|---|---|
| berry and/or fruit | 70-about 100 |
| and/or vegetable mixture | |
| natural fructose and/or | the rest. |
| sugar-containing product | |

Furthermore, the shape-giving formulation has been selected at the following components ratio, weight %:

| | |
|---|---|
| berry and/or fruit | 70-99 |
| and/or vegetable mixture | |
| natural fructose and/or | 1-30. |
| sugar-containing product | |

Furthermore, a feedstock for a berry and/or fruit and/or vegetable mixture can consist of apples and/or pears, and/or pumpkins, and/or carrots, and/or watermelon pulp, and/or melon pulp, and/or blueberry pulp, and/or grapes, and/or strawberries, and/or raspberries, and/or plums, and/or cherry-plums, and/or cherries, and/or sweet cherries, and/or blackberries, and/or apricots, and/or peaches, and/or gooseberries, and/or blackcurrant, and/or red currant, and/or cranberries, and/or cowberries, and/or sea-buckthorn, and/or cornelian cherries, and/or lemons, and/or mandarins, and/or oranges.

Furthermore, a shape-giving layer contains flavor additives.

Furthermore, as flavor additives, the shape-giving layer contains spicery and/or aromatic and/or flavoring substances of natural origin.

Furthermore, the product additionally contains a dressing layer, which dressing layer is made of food material located (dusted) over the body.

Furthermore, a food material of the dressing layer is selected from a group comprising coconut flakes, ground nuts, powdered sugar, or other foodstuffs applicable for usage as a dressing.

Furthermore, the body is formed into a twisted roll or a layered pie.

### DETAILED DESCRIPTION OF THE INVENTION

The suggested confectionary product, in contrast to that by prior art, contains a feedstock of natural origin only, namely: various fruits, berries, vegetables, and specially created mixtures thereof, thus, a product biological value significantly increases (owing to increased contents of vitamins, organic acids, ascorbic acid, pectin, minerals etc.). Furthermore, ready products being made of various berries-fruits-vegetables mixtures, said products will have various colors, from dark-blue (those containing blackberry and sugar) to bright-red (those containing cranberries and sugar). Correspondingly, such products will have the variety of tastes.

Moreover, neither natural nor dry egg white being used as a component in course of preparation of a berries-fruits layer, a dried shape-giving layer can be obtained with a thickness of 1 to 6 mm. At that, prepared products can be also consumed by those having allergy to eggs, as well as by vegetarians or by those keeping the fast.

The adjusted selected formulation of suggested confectionary products enables preparation of sufficiently thin shape-giving layers (from 1 to 6 mm thin) which are enough elastic and flexible by structure and, as such, can be easily twisted into a roll, or can be easily formed into a layered pie by placing one layer onto another, moreover, such rolls or pies can be easily cut into pieces according to the determined size while avoiding breaking the form of the body or breaking the layers as such.

The following examples are given to further explain the scope and spirit of the present utility model.

### Example 1

In order to prepare the apple- and raspberry-based products, we take 5 kg of apples and 2 kg of raspberries.

All the feedstock has been prepared in line with technological instructions upon confectionary production. The feedstock has been pre-prepared. Such preliminary preparation comprises stewing the apples, removing the pits and grinding the fruits. In turn, raspberries are enough soft by nature, therefore, these berries are not stewed but only ground fresh. The prepared feedstock is mixed, keeping a predetermined ratio, while using an industrial equipment, for example, a high-speed mixer, while adding fructose (2.0 kg) at a high speed until a homogenous mass is obtained during 15 to 25 minutes. Fructose can be substituted with a sugar-containing component: sugar and/or powdered sugar, natural honey or stevia extract and the like.

A prepared mass is poured out onto a pan while keeping a mass layer 5 to 10 mm thin, with further drying at the temperature 45° to 65° C., in the drying chambers, during 4 to 8 hours. At this step, used are drying chambers with convection drying method in combination with infrared emitters located throughout a drying space. A residual moisture of the layers is 25 to 45%. Thereby we reach a maximum concentration of vitamins and useful (healthy) substances per 1 g of a prepared product.

The prepared shape-giving layers are 1 mm to 6 mm thin.

The dried layers are shaped into bodies of two kinds of the products:

a body in form of a roll is shaped by twisting (turning) and is further cut into portions;

a body in form of a layer cake is shaped by putting layers one onto another and is further cut into portions.

A number of layers in a body can vary depending on weight of the prepared product.

The shaped products bodies are sprinkled with a powdered sugar and wrapped in a packing paper.

Ready products have a bright-crimson color, an apparent raspberry taste, at the cutting line of the product one can see thin layers (1 mm to 6 mm thin) which are not glued together. The ready products are stored at the temperature not higher than 10° C. during not more than 45 days.

### Example 2

Preparation of the Currants-Based Products.

The embodiment is realized similarly to Example 1, though, with using 5 kg of currants. In course of grinding, a natural fructose is added to the stewed mass of currants in the ratio 1.5:3.

The dried layers are shaped into bodies of two kinds of the products:

a body in form of a roll is shaped by twisting (turning) and is further cut into portions;

a body in form of a layer cake is shaped by putting layers one onto another and is further cut into portions.

A number of layers in a body can vary depending on weight of the prepared product. Correspondingly, the formed products have a dark-purple color, and a rich taste of currants.

Ready products are sprinkled with a powdered sugar and are wrapped in a packing paper.

### Example 3

In order to prepare a layered product based on apples and carrots, one takes 5 kg of apples and 5 kg of carrots. All the feedstock has been prepared in line with technological instructions upon confectionary production. Apples are stewed, pits are removed and fruits are ground. Carrots are peeled and stewed. The prepared feedstock is ground, keeping the predetermined ratio, while using the industrial equipment, for example, a high-speed mixer, while adding sugar (1.5 kg) at a high speed until the homogenous mass is obtained during 15 to 25 minutes. Sugar can be replaced with a sugar-containing component: powdered sugar, natural or artificial honey or mixtures thereof, honey, fructose and the like. A prepared mass is poured out onto a pan while keeping a mass layer 4 to 10 mm thin, with further drying at the temperature 50° to 55° C., in the drying chambers, during 6 to 10 hours. At this step, used are drying chambers with convection drying method in combination with infrared emitters located throughout a drying space. A residual moisture of the layers is 25 to 45%.

The prepared shape-giving layers are 1 mm to 6 mm thin.

Ready products have a bright-orange color, and taste similar to stewed carrot with an apple flavor, at the cutting line of the product one can see thin layers (from 1 to 6 mm thin) which are “softly” glued together.

In order to develop novel flavors, a confectionary product can be prepared with addition of flavor additives. For this purpose, in course of grinding a feedstock, natural spices and/or flavoring substances are added to the mass formulation. These can be mint leaves, cardamom, cinnamon etc.

As well, for instance, ready product can contain layers of various origins, prepared from various berries/fruits/vegetables, thus providing the confectionary products with variety and original taste.

Bodies of the prepared confectionary products are made of sufficiently flexible and elastic layers, have improved organoleptic properties, particularly, are of original taste, flavor and color, depending on used berries/fruits/vegetables. Furthermore, the claimed technical solution provides for preparation of the ready product having a high concentration of vitamins and microelements per 1 g of the product, because a berry or fruit or vegetable basis is not subjected to a long-term high-temperature processing, moreover, thanks to economic water loss (boiloff) a maximum amount of valuable nutritional components of the natural feedstock is being kept. Furthermore, disclosed products do not contain the products of animal origin. The proposed products are recommended for consumption by diabetic patients, in winter and spring seasons when the immunity weakens, at the post-disease rehabilitation period.

1. A confectionary product comprising;
a body having of at least one shape-giving layer made of at least one of a pre-prepared berry, a fruit, and a vegetable mixture with optional added natural fructose and/or sugar-containing product,
wherein the at least one shape-giving layer is 1 to 6 mm thin, and includes a shape-giving layer formulation selected according to the following components in weight %:

| | |
|---|---|
| berry and/or fruit | 70-about 100 |
| and/or vegetable mixture | |
| natural fructose and/or | the rest. |
| sugar-containing product | |

2. The confectionary product according to claim 1, wherein the shape-giving layer formulation is selected according to the following components in weight %:

| | |
|---|---|
| berry and/or fruit | 70-99 |
| and/or vegetable mixture | |
| natural fructose and/or | 1 to 30. |
| sugar-containing product | |

3. The confectionary product according to claim 1, wherein a feedstock for the at least one berry, fruit, and vegetable mixture includes at least one of apples, pears, pumpkins, carrots, watermelon pulp, melon pulp, blueberry pulp, grapes, strawberries, raspberries, plums, cherry-plums, cherries, sweet cherries, blackberries, apricots, peaches, gooseberries, blackcurrant, red currant, cranberries, cowberries, sea-buckthorn, cornelian cherries, lemons, mandarins, and oranges.

4. The confectionary product according to claim 1, wherein the shape-giving layer contains flavor additives.

5. The confectionary product according to claim 4, wherein the flavor additives includes at least one of spices, aromatics, and flavoring substances of natural origin.

6. The confectionary product according claim 1, wherein the product is additionally covered with a dressing layer made of food material, located over the body.

7. The confectionary product according to claim 6, wherein the dressing layer of food material is selected from coconut flakes, ground nuts, powdered sugar, or other foodstuffs which can be used as a dressing layer.

8. The confectionary product according to claim 1, wherein the body is shaped into the twisted roll or a layered pie.
